(19) United States
(12) Patent Application Publication
(10) Pub. No.: US 2012/0191527 A1
(43) Pub. Date: Jul. 26, 2012

(54) PREDICTIVE ANALYSIS OF DATA

(76) Inventors: Tal Reichert, Medford, MA (US); Ido Nimrod Sadeh, Ramat Gan (IL)

(21) Appl. No.: 13/010,364

(22) Filed: Jan. 20, 2011

(51) Int. Cl. G06Q 30/00; G06F 17/30

(52) U.S. Cl. 705/14.41; 705/14.53; 707/748; 707/E17.084

(57) ABSTRACT

Disclosed are methods, computer program products, systems, and devices, including a method, performed by execution of computer readable program code on one or more processing-based devices, that includes receiving data relating to past customer activities by at least one customer, receiving data relating to future events available to a plurality of customers, and determining data relating to promotion of opportunities corresponding to the future events to be presented to the at least one customer based on the data relating to the past customer activities by the at least one customer and on the data relating to the future events available to the plurality of customers.

### BACKGROUND

This disclosure relates to predictive analysis of data (such as commercial data), and more particularly to predictive determination of customers behavior based on past behavior in relation to commercial activities such as purchasing and betting transactions.

Point-of-Sale (POS) devices, including POS with digital signage devices to display graphics and information to customers (e.g., to display advertisements and/or other audiovisual items to customers/consumers) are used to perform commercial transactions and activities (e.g., to complete sales transactions), and to generally facilitate commerce-based activities.

For example, one use of POS devices is to enter transactional orders, e.g., through the assistance of a sales-person, or by the consumer him/herself (when the POS device is adapted to be a self-serve POS device). Another example of the use of POS' to facilitate commercial activities is their use to present available betting opportunities (e.g., in relation to legal betting activities, such as government-sanctioned sporting events, including horse and dog racing, sporting events, etc.) and to enable customers accessing and interacting with such POS' to make/submit bets.

### SUMMARY

The present disclosure is directed to technology, systems, methods and articles to perform processing, including predictive determination of customers' behavior for future events (e.g., betting events), and presenting customers seeking to submit bets with various betting options that may appeal to those customers. In some embodiments, the technology, systems, methods and articles may include a method, performed by execution of computer readable program code on one or more processing-based devices, that includes receiving data relating to past customer activities by at least one customer, receiving data relating to future events available to a plurality of customers, and determining data relating to promotions of opportunities corresponding to future events to be presented to the at least one customer based on the data relating to past customer activities by the at least one customer and on the data relating to the future events available to the plurality of customers.

The systems, methods and articles described herein may contribute to an increase in revenues generation by offering customers the opportunity to engage in commercial activities that may appeal to them, presenting targeted betting opportunities to customers based on the customers' previous behavior so as to facilitate the customers' decisions to proceed with betting transactions, etc.

In some embodiments, the technology, systems, methods, and articles described herein enable:
Increase the customers' purchases (e.g., betting purchases) within a visit to an outlet (betting shop, a retail outlet, etc.)
Promote targeted predictive, history-analysis-based offers, providing suggestions to customers about additional betting opportunities.
Increase the value derived from customers holding special commercial cards (VIP cards, customer issued betting cards, etc.) offering the customers holding such cards targeted promotions and special offers.
Deliver enhanced customer experience through customers' interaction with POS devices configured to facilitate interactive commercial activities with the customers.

In one aspect, a method performed by execution of computer readable program code on one or more processing-based devices is disclosed. The method includes receiving data relating to past customer activities by at least one customer, receiving data relating to future events available to a plurality of customers, and determining data relating to promotion of opportunities corresponding to the future events to be presented to the at least one customer based on the data relating to the past customer activities by the at least one customer and on the data relating to the future events available to the plurality of customers.

Embodiments of the method may include any of the features described in the present disclosure, including any of the following features.

The past customer activities may include betting activities.

The data relating to past customer activities by the at least one customer may include data arranged in a customer index comprising parameters representative the behavior of the at least one customer. Each parameter of the customer may be associated with a rank value representative of an importance of the respective parameter relative to other parameters of the index.

The parameters may include one or more of, for example, preferred odds favored by the at least one customer associated with the index, an average daily transactions representative of the number of transactions performed by the associated at least one customer during a single day, favorite subject data representative of individual subjects favored by the associated at least one customer, and/or percent stake wagers per event subject values representative of the percentages of bets the associated at least one customer wagers on respective event subjects.

Determining promotion of the future events may include generating a promotion presentation promoting at least one of the opportunities corresponding to the future events to be presented to the at least one customer based, at least in part, on the rank values for the parameters of the customer index for the at least one customer.

The generated promotion presentation may includes the at least one future event and customer options available in relation to the at least one future event.

The available customer options may include betting options determined based on the customer index parameters for the at least one customer to which the generated promotion is presented.

Generating the promotion presentation promoting the at least one of the future events may include generating the promotion presentation based, at least in part, on the rank values for at least some of the parameters of the customer index for the at least one customer and using pre-determined rules applied to the data arranged in customer index.

The pre-determined rules may include rules configured to cause determining whether one or more of the parameters of the index represent a particular behavior, and based on a determination that the particular behavior is represented by the one or more parameters of the index, causing the index to be modified such that the modified index results in additional opportunities to be promoted in response to particular one or more future events.

The data relating to past customer activities by the at least one customer may include data arranged in a plurality of customer indices comprising parameters representative the behavior of respective customers associated with each of the plurality of customer indices, wherein each parameter in each of the plurality of customer indices is associated with a rank value representative of an importance of the respective parameter relative to other parameters in the respective index. The method may further include selecting at least some of the parameters of each of the plurality of customer indices, the selected at least some of the parameters corresponding to parameters with respect to which the respective customers associated with each of the plurality of customer indices include data representative of similar behavior for all of the respective customers associated with each of the plurality of customer indices for the selected at least some of the parameters.

The method may further include communicating the data relating to promotion of the opportunities corresponding to the future events to one or more point-of-sale devices deployed in one or more geographical locations.

The method may further include receiving information about a transaction, the transaction including information about a first commercial opportunity selected by the at least one customer from one or more available opportunities, and determining at least one second commercial opportunity to be presented to the at least one customer based on the received information and based on effective measures that are each associated with at least one combination from a set of combinations that each includes the first commercial opportunity selected by the customer and a corresponding offer of cross-sale of at least one other commercial opportunity from a plurality of commercial opportunities, each of the effectiveness measures being representative of a likelihood that the at least one other commercial opportunity to be offered to the at least one customer would be accepted when offered in combination with the first commercial opportunity selected by the at least one customer. The method may further include communicating information to the customer about a cross-sale offer to select the determined at least one second commercial opportunity.

In another aspect, a computer program product residing on a computer readable storage device comprising computer instructions is disclosed. The computer instructions, when executed on one or more processor-based devices, cause the one or more processor-based devices to receive data relating to past customer activities by at least one customer, receive data relating to future events available to a plurality of customers, and determine data relating to promotion of opportunities corresponding to the future events to be presented to the at least one customer based on the data relating to the past customer activities by the at least one customer and on the data relating to the future events available to the plurality of customers.

Embodiments of the computer program product may include any of the features described in the present disclosure, including any of the features described above in relation to the method, and the features described below.

The computer instructions may further include instructions to further cause the one or more processor-based devices to generate a promotion presentation promoting at least one of the opportunities corresponding to the future events to be presented to the at least one customer based, at least in part, on the rank values for the various parameters of the customer index for the at least one customer.

In a further aspect, a system is disclosed. The system includes at least one processor-based device, and a storage device coupled to the at least one processor-based device. The storage device stores computer instructions that when executed on the at least one processor-based device cause the at least one processor-based device to receive data relating to past customer activities by at least one customer, receive data relating to future events available to a plurality of customers, and determine data relating to promotion of opportunities corresponding to the future events to be presented to the at least one customer based on the data relating to the past customer activities by the at least one customer and on the data relating to the future events available to the plurality of customers.

Embodiments of the system may include any of the features described in the present disclosure, including any of the features described above in relation to the method and the computer program product, and the features described below.

The generated promotion may include the at least one future event and customer betting options available in relation to the at least one future event.

The system may further include a point-of-sale (POS) device including a display device, a user input device to receive user input including user selection of an opportunity from the opportunities corresponding to the determined data relating to the promotion of the opportunities, and a communication transceiver to transmit to the at least one processor-based device at least the user selection.

Details of one or more implementations are set forth in the accompanying drawings and in the description below. Further features, aspects, and advantages will become apparent from the description, the drawings, and the claims.

### BRIEF DESCRIPTION OF THE DRAWINGS

FIG. 1A is a schematic diagram of a multi-POS (point of sale) system configured for adaptive learning and/or predictive analysis of commerce-based activities, such as betting transactions.

FIG. 1B is a diagram of an example of an implementation of a distributed server system to process customers' data, and perform a predictive analysis,

FIG. 2 is a schematic diagram of a generic POS device.

FIG. 3 is a diagram of an example customer index.

FIG. 4 schematic diagram of a generic computing system.

FIG. 5 is a flowchart of a procedure to generate and present promotions of commercial opportunities to customers.

Like reference symbols in the various drawings indicate like elements.

### DETAILED DESCRIPTION

Disclosed are systems, methods and articles for processing of commerce-based activities, including a method that includes receiving data relating to past customer activities by at least one customer, receiving data relating to future events available to a plurality of customers, and determining data relating to promotions of opportunities corresponding to the future events to be presented to the at least one customer based on the data relating to the past customer activities by the at least one customer and on the data relating to the future events available to the plurality of customers.

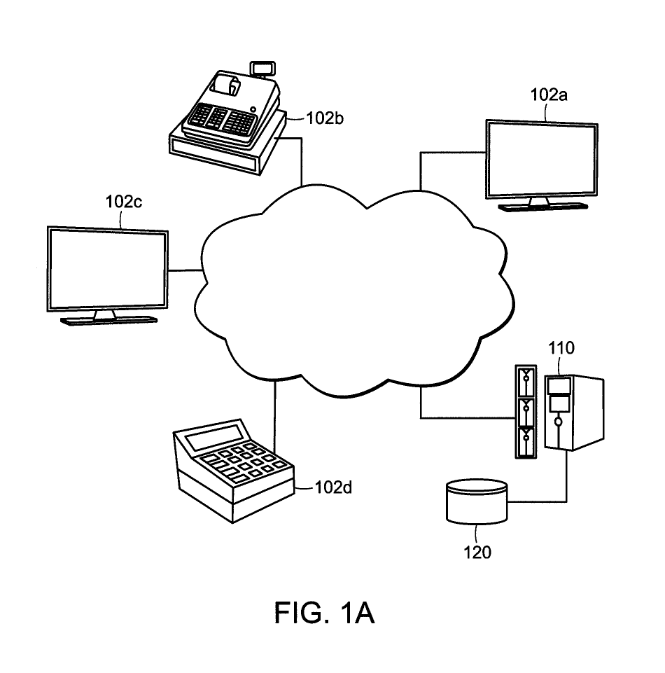

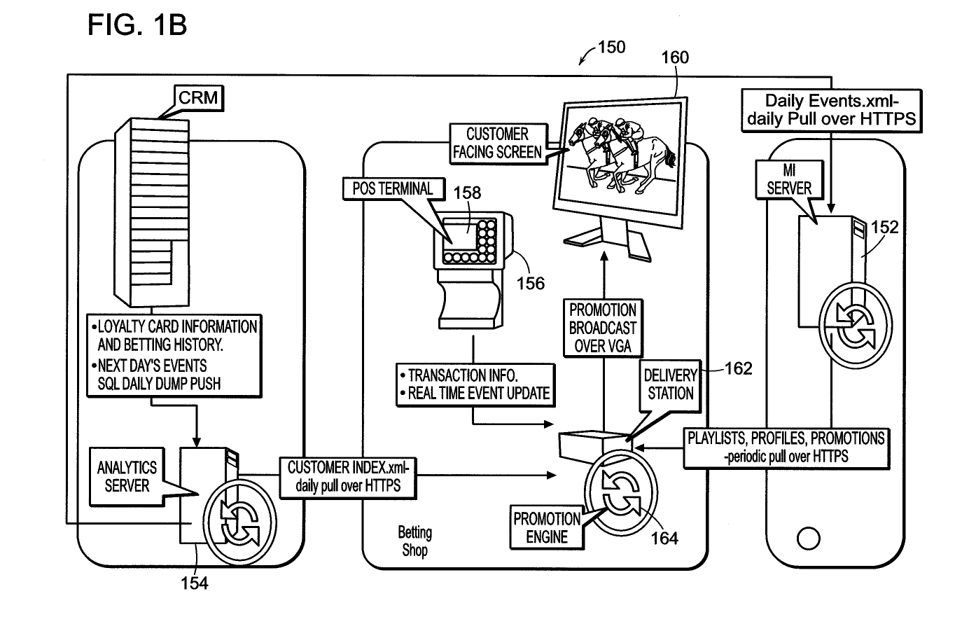

With reference to FIG. 1A, a schematic diagram of a multi-POS (point of sale) system 100 configured for adaptive learning and/or predictive analysis of commerce-based activities is shown. The system 100 may be configured to enable various types of commercial activities, including retail activities, betting activities, and other types of commercial activities. While the system 100 may be configured to facilitate various types of commercial activities, for the purpose of illustration, the implementations described herein will focus on betting-type commercial activities, particularly government-sanctioned betting activities (as may be permitted by law in various jurisdictions) that include a distributed network of POS device through which customers may execute betting transactions, and through which promotional presentations, to promote commercial activities that may be of interest to the customer, may be presented. Thus, in some implementations, the system 100 may include one or more Point-of-Sale (“POS”) devices 102a-d that are deployed in one or multiple outlets. For example, the POS devices 102b and 102d may be located at various retail outlets/branches (e.g., selling goods), fast-food outlets, etc. The POS devices 102a and 102c, on the other hand, may be deployed in locations/outlets authorized to operate betting machines/interfaces. The POS devices 102a and 102c (and/or the devices 102b and 102d) may be configured to present betting opportunities to customers accessing them. Each outlet may include one or more of the individual POS devices depicted in FIG. 1A.

In some embodiments, one or more of the POS devices, for example, the POS device 102b, may be an electronic cash register operable by an operator (e.g., in a fast-food joint, a supermarket, or some other retail outlet). In some embodiments, one or more of the POS devices may include, for example, a check-out point in which a user completes commercial transactions without the assistance of a live operator by, for example, inputting information about an item or service it wishes to purchase through a suitable input-interface such as, for example, a touch screen, an optical scanner, a keyboard, a RFID sensing device, etc. In some embodiments, one or more of the POS devices may be a POS device such as the one described, for example, in U.S. patent application Ser. No. 11/314,713, entitled “Systems and methods for automatic control of marketing actions”, and U.S. patent application Ser. No. 11/611,481, entitled “Exposure-Based Scheduling,” the contents of both of which are hereby incorporated by reference in their entireties. An example of a POS device that may be used is the POS device implementation developed by Odysii Ltd.

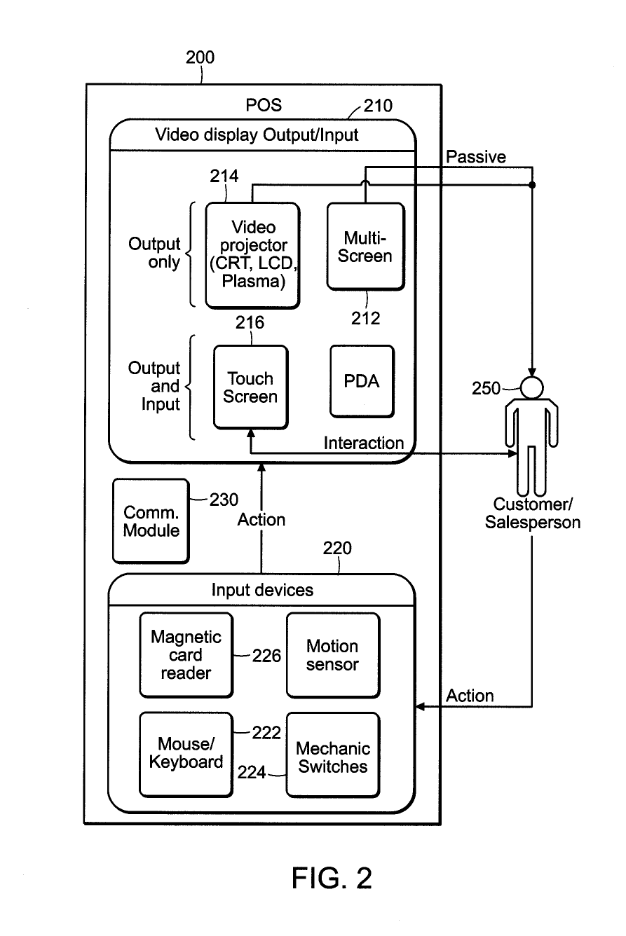

With reference to FIG. 2, a schematic diagram of a generic POS device 200, which may be similar to any one of the POS devices 102a-d illustrated in FIG. 1A, is shown. The POS device 200 includes an input/output display 210. The display 210 can include one or more of display devices such as a multi-screen device 212, and/or a video projector 214. Examples of suitable video projector devices that the display 210 may use include cathode-ray-tube based devices, liquid crystal display type devices, and/or plasma type display devices. Other types of display devices may be used.

In some implementations, the display 210 may further include devices whose display surface is configured to receive input from a user 250 (such as a customer or a salesperson) interacting with the POS device 200. Thus, in some embodiments the display unit 210 may include a touch screen device 216 having a touch sensitive surface to enable users to enter data and/or make selections (e.g., betting selections in the course of executing betting transactions) by directly touching areas of the screen as directed by graphical and/or audible prompts appearing on the screen.

As further shown in FIG. 2, the POS device also includes input device unit 220. The input device unit may include one or more of the input devices depicted in FIG. 2 to enable the user 250 to enter data and make selections in a variety of ways. Thus, for example, the input device unit 220 may include a mouse/keyboard device 222, and/or mechanical switches unit 224. The input device unit 220 may include other types of data entry and/or data collection devices, including a magnetic and/or optical reader 226 (e.g., to swipe magnetic cards such as credit or debit cards).

As will be described in greater details below, input collected by one or more of the various POS devices may be sent to a central computing system 110 for recordation and processing. Thus, each POS device may include a communication module 230, such as, for example, a transceiver, a network gateway, a wireless transceiver, etc., to transmit information collected or received at the POS 200 to a remote device, such as another POS device or a central server. Alternatively and/or additional, the collected data may be locally recorded and/or processed to generate resultant data at a processor-based device constituting part of the POS device collecting the customer's input. Information collected by POS device 200 may be first stored in local storage (e.g., volatile and non-volatile memory, not shown) of the POS device 200.

Thus, in some embodiments, input collected via a POS device is communicated to, for example, the central computing system whereupon the received input is used, for example, to determine betting opportunities (and/or other commercial opportunities) to present to a user who may be interested in such determined commercial opportunities. In some embodiments, information about betting transactions executed by the user/customer may be used to update a record (also referred to as a customer index) that maintains data representative of the customer's commercial behavior, to thus enable determining additional commercial opportunities that may be of interest to the customer. Alternatively and/or additionally, in some embodiments, the data received from a POS device (e.g., upon completion of the current commercial transaction performed by the user) may be used to access data regarding commercial transactions/activities from a plurality of customers, to determine one or more additional commercial opportunities be presented to the customer (e.g., one or more betting opportunities that may be offered to the customer as a cross-sale opportunity). The one or more additional opportunities so determined may be communicated to the POS from which the customer's input was received. Such information may include particulars regarding the one or more additional commercial opportunities, including, when the opportunities pertain to possible betting opportunities, a description of the present event or future events with respect which bets may be made (e.g., future races, future sporting events), proposed bets that may conform to the customer's preferences and betting behavior, any applicable discounts or specials to be offered as part of the cross-sale commercial opportunity, etc.

Turning back to FIG. 1A, as noted, in some implementations, at least one of the POS devices 102a-d is in communication with a computing system (such as a central server) 110. Information collected by any of the POS coupled to the computing system 110 is sent to the computing system 110, whereupon that information is processed. Particularly, the computing system 110 receives information from the various POS devices, including information regarding a commercial transactions that have been completed or are about to be completed by the customer. For example, in circumstances where a transaction pertains to placement of bets, the information communicated to the computing system 110 may include the particulars of the bet to be placed (e.g., the event with respect to which the bet is being made), the size of the wager the customer is placing, the specific outcome the customer is placing a bet for (e.g., which horse will win an upcoming race, which football team will prevail in an upcoming match, etc.) and the odds associated with the specific outcome the bet is being placed for (the odds may be determined by a third party, such an independent organization to assess the particular odds for certain outcomes associated with an event), etc. The computing system receives from the POS devices the information corresponding to transactions that have been completed or will be completed, and/or information about a customer or about the particular POS sending the information, to determine one or more commercial opportunities (e.g., bets) the customer may be interested in completing. Such one or more commercial opportunities may be cross-sale opportunities to offer supplemental opportunities to a customer that already has made a selection about a particular opportunity, or may be initial opportunities presented to the customer. The determination of the opportunities is based, in some embodiments, at least in part on data (maintained at the system 110 or elsewhere) that is representative of the past commercial behavior and/or activities of the customer (or of customers who have accessed the POS in question). In some embodiments, the computing system may also receive information from other systems (e.g., backend systems of the company operating the POS devices).

In some implementations, the system 110 may be a distributed system comprising of several remotely situated servers that are each configured to perform some or all of the processing operations to enable presentation of commercial opportunities to customers, collecting data regarding selections made by customers, causing execution of the selected transactions (e.g., either directly, or by communicating customers' betting selections to a third party server that is authorized to execute bettors' bets), updating and recording data relating to customers' behavior (which can subsequently be used to determine suitable commercial opportunities for customers accessing and using POS devices), etc.

Thus, with reference to FIG. 1B, an example of an implementation of a distributed server system 150 to process customers' data, and perform a predictive analysis, is shown. Like the system 100 of FIG. 1A, the system 150 is also configured to collect and manage data received from a distributed network of POS devices, determine commercial opportunities that may be of interest to particulars customers, and/or generate promotions, comprising of promotions for one or more commercial opportunities, that are then sent to one or more of the POS devices of the system 150. As shown, the system 150 includes a first server 152 (labeled as the MI server) that is configured to manage content that is communicated and presented to POS devices, and to generate and manage rules that are applied in the course of determining commercial opportunities to present to customers. In some embodiments, the server 152 may serve multiple client machines that independently serve different networks of POS devices, or other types of devices. In some embodiments, the server 152 may be configured to generate playlists (e.g., in accordance with procedure described in U.S. patent application Ser. No. 11/611,481, entitled “Exposure-Based Scheduling,” the content of which is hereby incorporated by reference in its entirety) that include presentations promoting commercial opportunities (e.g., betting opportunities) to a customer based on data relating to past behavior of the customer accessing the POS device and based on data relating to future events. In some embodiments, for example, where data relating to customers' past behavior is delivered to local machines (i.e., at the outlet where customers are present), and the actual promotions are determined and presented at the local machines, the server 152 may be configured to determined rule sets to govern the procedures for determining which opportunities are to be selected and presented to local customers, and to deliver those rules sets to the local machines (e.g., to a delivery station 162 of a POS device 156).

Also included in the distributed system 150 is a second server 154, which in the example implementation of FIG. 1B is operated by a party administering and managing the commercial transactions that are performed via one or more POS devices. The server 154 is configured to, in some embodiments, to mine through customer data received from POS devices and/or from other sources (including, for example, the first server 152) and generate one or more customer indices that include data representative of customer behavior in relation to commercial transactions similar the commercial opportunities that are to be presented to the customers served through the network of POS devices of the system 150. The second server is generally also configured to receive data relating to future events with respect to which commercial opportunities are to be presented to the customer, and to use that data (which may be provided as a list of future events spanning any future time period), along with the data representative of the customers' behavior with respect to commercial transactions, to determine commercial opportunities to present to customers using the system 150. In some embodiments, the second server 154 is also configured to send the data relating to future events to the first server, whereupon the first server processes the received data as part of its overall data management functionality, to use the data regarding the future events to generate and/or manage rules that may be used in the procedures to generate promotional presentations to promote commercial opportunities, etc.

Also depicted in FIG. 1B is an example of one POS device 156 that is in communication with the first and second servers. The depiction of one POS device in FIG. 1B is for illustration purposed only, and additional POS devices may be used in implementations of the system 150. As shown, the POS device 156 is generally deployed in an outlet, such as a betting shop, that customers can visit to review commercial opportunities and consummate transactions in relation to selected opportunities. The POS device 156 may include multiple screens/monitors (such as screens 158 and 160) to implement a user output interfacing system. For example, the main POS device 156 (including the computing-based device implementing the interfacing application) may include a primary screen through which a local administrator may interact with the POS device and/or with the main server 154 in communications with the POS device 156.

The POS device 156 may communicate content (including content regarding potential commercial opportunities) to the screen device 160 through which one or more customers interact as well as to send content to additional screens (not shown) that are in communication with the POS device. Thus, in such embodiments, the POS device 156 may function as a local server to serve a plurality of screens (e.g., touch screens) configured to present content regarding commercial opportunities (e.g., betting opportunities) to customers, and to receive from those customers responses indicative of selections/decisions in relation to those commercial opportunities. Thus, as depicted in FIG. 1B, the POS device 156 may receive transaction information provided by a user through an input interface (e.g., which may be coupled to the output interface, for example, when the screen 160 is a touch screen).

The transaction information, as well as other information (e.g., event update information) may be communicated, in some embodiments, to a delivery station 162 which may server as a communication node (wireless, wire-based, and/or based on any type of communication protocols) configured to receive and transmit data from various device communicating with it. In some embodiments, the delivery station may be part of the POS device itself and need not be a separate stand-alone module. As shown, in the embodiments of FIG. 1B, the delivery station 162 is configured to receive playlists, profiles, and promotions from the first server 152, and to receive customer index data (i.e., data representative of customer behavior in relation to past commercial activities and opportunities) from the second server 154. These data records sent from the first and second servers may be pulled periodically (e.g., once an hour, once a day, once a week, etc.) using, for example, HTTPS (secure Hypertext Transfer Protocol). The delivery station may, in turn, transmit information pertaining to transactions (e.g., customers selections vis-á-vis commercial opportunities) to, for example, the second server 154, whereupon, the commercial transactions selected by the customers may be executed (through the server 154 or through a third party server configured to received data about commercial transactions, such as bets, customers wish to execute, and to perform the operations necessary to execute those transactions). Data transferred to and from the delivery station may be transferred in any suitable format, including, for example, as Microsoft Excel files.

As further illustrated in FIG. 1B, in some embodiments, the second server 154 communicates to the first server 152 data relating to customers and/or transactions performed by the customers so that the first server can record and effectively manage the information, and also generate, based at least in part on the data received and recorded, playlists, profiles and promotions regarding commercial opportunities that can be presented to customers interacting with the system 150 (or the system 100) at particular POS devices (such as the POS device 156). In some implementations, data sent from the second server 154 to the first server 152 may include the following information:
For each customer, a customer unique identifier (e.g., 14 digits card ID);
For each customer, the customer's profile information, including, for example, age, purchase frequency, zip code, etc.;
For each customer, the customer's betting history (i.e., past betting transactions) which may be based on the period since the last time data was sent from the server 154 to the server 152, or may be based on a different time span;
Archived betting events properties to match with the available-events' properties;
Data regarding future events, for example, data regarding the following day's events, which includes, for example, listing of the following day's upcoming events to be promoted at the various locations where customers come to review and select from available commercial opportunities. Each event and opportunity may be associated with its own unique ID (e.g., so as to enable cross-referencing the events with price update information received throughout the day). As noted above, in some implementations, the server 152 may generate playlists for presentation on POS devices at various locations, with the playlists being generated based, at least in part, on local characteristics of the locations where they are to be presented (e.g., demographics, past general behavior of customers at those locations, etc.). The playlists may then be delivered to delivery stations at the respective locations at which they are to be presented, or may be delivered to individual POS devices deployed at the various locations.

As noted, determination of what opportunities corresponding to future events (e.g., betting opportunities corresponding to various sporting events, such as horse racing) that are to be promoted to various customer may, in some embodiments, be based on past behavior of the customers to which the opportunities are to be presented, and based on what future events will occur. In some circumstances, the promotions of commercial opportunities in relation to future events are generated for specific customers. This generally can be implemented where customers access POS devices connected to the system 100 (or the system 150) and identify themselves to the system, e.g., using a unique ID that has been previously assigned, with ID being provided by the user via a keyboard or the touch screen, by swiping a customer-issued ID card, a customer-issued credit card, etc. In response to receiving the identity of the customer, a customer record, also referred to as a customer index, may be accessed. This customer index may be already stored on the POS device (or on a delivery station when a configuration similar to that depicted in FIG. 1B is used). For example, in some embodiments, a server serving the various outlets and their POS devices and/or delivery stations, may send each day customer indices for all customers who have visited the particular outlet over some pre-determined period of time (e.g., within the last 180 days). By providing customer indices in advance of the commencement of activity by customers at the receiving outlets, accessing the required records of customers' past commercial activities can be expedited (e.g., similar to operation of a cache).

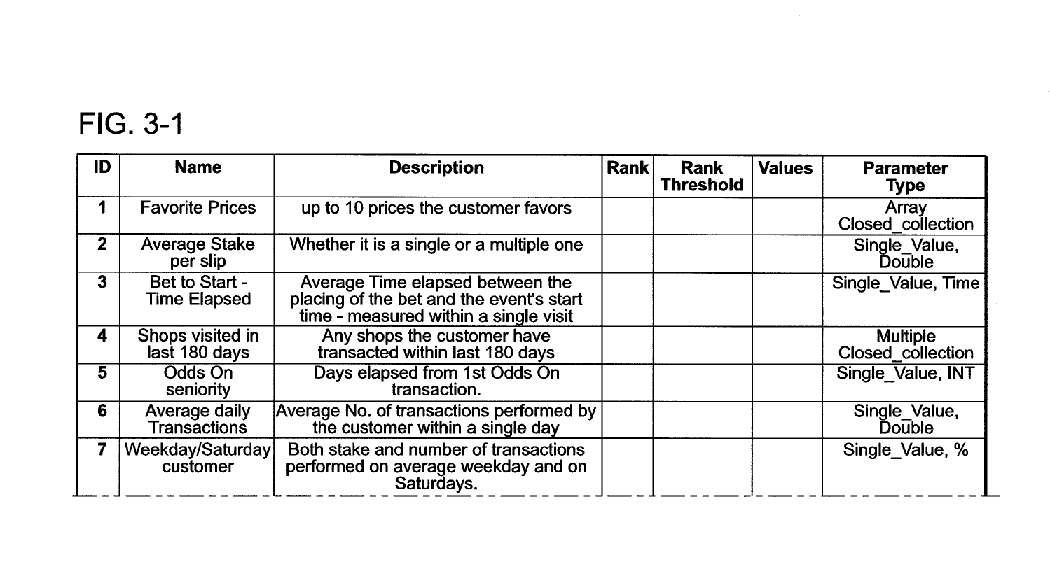

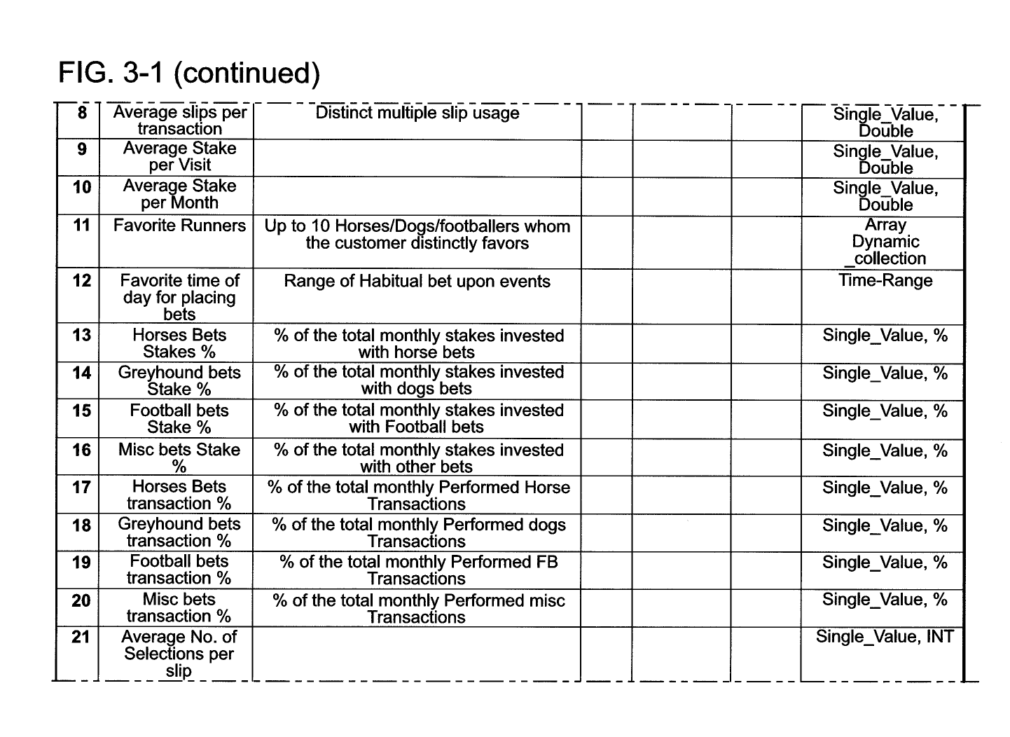

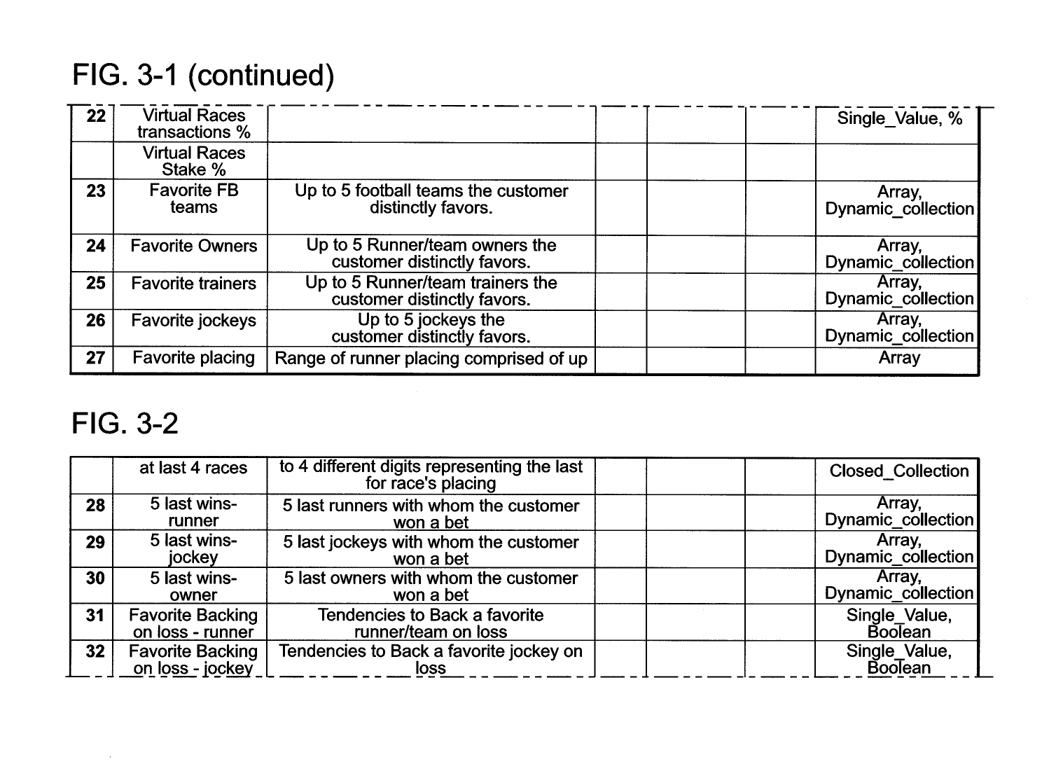

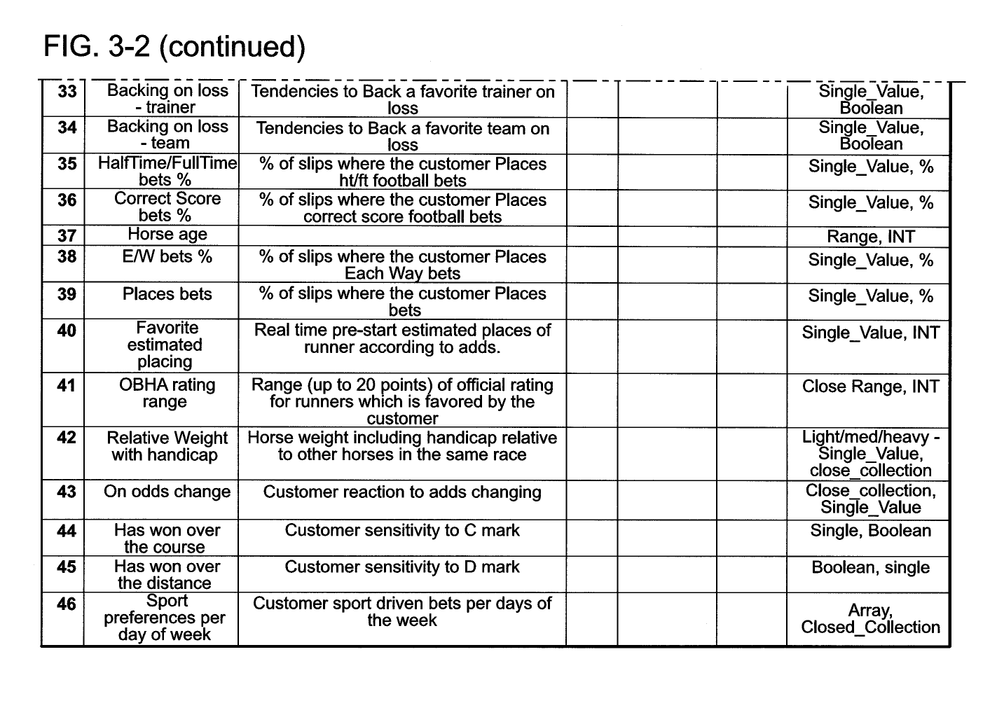

The customer index record is generally associated with at least one customer and includes data arranged in a plurality of parameter records (i.e., each index includes a plurality of parameters) that are representative of the behavior of the at least one customer associated with the index (or in other words, the parameters to which the associated customer is sensitive, as may be determined from the customer's past transactions). With reference to FIG. 3 (split over two drawings sheets labeled FIGS. 3-1 and 3-2), a diagram of an example customer index is shown. In the particular example of FIG. 3, the customer index includes 46 different parameters that each includes data representative of the associated customer(s) past behavior/activities. However, fewer or additional parameters may be included, depending on the degree of analysis and/or on how nuanced the analysis is required to be. In some embodiments, each of the records relating to the index' parameters may include the following information/attributes (arranged in corresponding fields):
Parameter ID: unique parameter ID.
Parameter Name—descriptive string of the nature of the parameter.
Rank: an attribute having a value between 0 and 1, to designate the rank, or weight, of the parameter within the index. The rank may be based on mined data that can indicate how important that parameter is for customers making transaction decisions (this component of the rank value may be computed, for example, using a data mining procedure). In some embodiments, the rank may represent a probability that a customer would accept an opportunity matching the nature of the associated parameter. In some embodiments, the rank value may also be based on an importance (normalization) value entered/controlled by administrators of the system based on human knowledge of customers' behavior.
Rank Threshold: a pre-specified value below which the parameter is ignored.
Values: single, multiple or range of values referring to the parameter name.
Parameter Type: A definition of the parameters processing and valid value types.

In some embodiments, each parameter may also include a “responsiveness rank” attributes that is representative of the responsiveness of the customer to a promotion triggered at least in part, by the associated parameter. Thus, parameters associated with low responsiveness rank values may have less of an effect in determining what opportunities are to be promoted as opposed to parameters associated with relatively high responsiveness rank. Additional or fewer attributes/properties may be included with each parameter record of a customer index.

In some implementation, promotions of commercial opportunities to be presented to a customer(s) associated with the index used may be generated according to procedures (e.g., pre-defined rules) to select at least some of the parameters in the index based, at least in part, on the parameters' ranks. For example, consider parameter 1, “Favorite Prices” of the example customer index shown in FIG. 3. This parameter specifies one or more prices (e.g., odds, such as 2:1, 3:1, etc.) that the associated customer favors. If the rank associated with this parameter indicates that the customer overwhelmingly places bets strictly for opportunities in sporting events matching the specified odds, with all other parameters having ranks indicating that they are of no importance to the customer (this would happen for example, if for all other parameters the respective computed ranks are less than their rank thresholds), then under these circumstances the opportunities to be promoted and presented to the customer may be for future events and particular outcomes matching the customer's favorite odds.

In circumstances where several parameters have associated rank values that exceed the specified thresholds, various rules/procedures may be applied to determine appropriate opportunities to present to the customer. For example, a decision tree may be implemented to select appropriate opportunities (from the outcomes associated with the future events with respect to which bets can be placed). For example, consider a situation where the customer index for the current customer interacting via a POS device indicates that the associated customer favors particular horses (as specified, for example, in parameter 11 of FIG. 3), or favors horses owned by particular owners (as indicated in parameter 24 of the example customer index of FIG. 3). Additionally, assume that, in this example, the data of future events specifies that one of the horses favored by the customer is going to race in one of those future events, that that horse has associated odds of winning that match one of the customer's favored odds (as specified in the “Favorite Prices”), and that the time between the current time and the event falls within a specified time range for a parameter indicating how much time into the future are events the customer tends to bet on. Thus, in this example a determination may be made to generate a promotion promoting the particular horse and the associated odds, and presenting that promotion to the customer.

In some embodiments, determination of the opportunities to promote may be performed using learning machines (e.g., implemented, for example, using neural net systems) that accept as input the data relating to future events and the data relating to customers' behavior (arranged, for example, in one or more customer indices), and based on that data determines opportunities to present to the customers.

In some embodiments, several opportunities may be presented to the customer who may then choose one or more of those promoted opportunities. If none of the promoted opportunities appeals to the customer, the customer may indicate so to the system (via the POS device through which the customer is interacting), and in response, additional, different opportunities may be determined based on the customer's past behavior and the data relating to the future events. The determination of additional opportunities to promote when none of the first set of promotions appealed to the customer may take into account the negative response the customer had to the promotion of the first set (i.e., the customer's response may affect the selection of parameters and the extent of their use to generate a second of promotions, and may also be used to update the parameter properties, such as rank, in the customer's index). In some embodiments, the customer may also request to manually navigate and review the opportunities available, which may be performed through screens and menus available on the POS device to review future events and customer options (e.g., possible outcomes on which bets can be placed) available to the customer.

In some embodiments, the index records may be associated with a particular locale (or POS device) rather than with a specific customer. For example, certain betting shops may have index records associated with them, which may be similar to the example index shown in FIG. 3, but which maintain data representative of the general behavior of customers in the outlet (i.e., the index is a generic profile representative of past behavior of customers placing bets through the POS device of the outlet/shop associated with the index record).

The generation of a customer index may generally be performed at a server (e.g., the server 110 of FIG. 1A, or either of the servers 152 and 154 shown in FIG. 1B) based on processing rules that use raw data regarding the customer's activity (e.g., the particulars of a transaction consummated by the customer, including the date and time, the wager, the particulars of the bet placed, etc.) to parse the data into any number of parameters descriptive of the behavior/patterns of the customer's activity.

In some implementations, a generic index (also referred to as a profile) may include at least some of the 1-N parameters of a typical index associated with a specific customer(s). Such a profile is configured to support the application of a promotion strategy to a group of customers sharing similar patterns. Thus, in such implementations, one or more profiles may be generated by selecting at least some of the parameters of each of a plurality of customer indices, with the selected at least some of the parameters corresponding to parameters with respect to which the respective customers associated with each of the plurality of customer indices include data representative of similar behavior for all of those customers. A profile that includes at least some of the parameters used in regular customer indices may be configured as follows:
ID: a unique identification.
Profile Name: string, descriptive human name.
Priority: Range (e.g., 1-99) the highest priority profile is chosen to represent parameter-belonging customers when they belong to various profiles. Customers who, based on their index customer values, do not belong to any profile, may be handled using automatic promotion generation.
Trigger: an attributes that determines when to load a set of profiles (e.g., to a POS, a delivery station, one of the servers, etc.)
Parameters: Auto-complete, comma-delimited-multiple-value combo box, parameters. The declaration of 1 . . . N parameters with/without rank range and value declarations may be supported. The declared parameters that match with the customer index parameters will determine a customer's affiliation to a profile.

In addition, when profiles are to be used to generate promotions available to multiple customers, a rule set associated with the profiles may also be retrieved and used to generate the promotions (e.g., via a promotion engine, such as promotion engine 164, which is coupled to a delivery station in a particular locale in implementations similar to those depicted in FIG. 1B).

In some implementations, pre-defined rules (that may be applied to customer indices or profiles) may include rules that cause an index/profile to be modified. For example, if a customer belongs to a certain profile (as specified by some of the rules), a determination may be made to modify the index/profile (e.g., for promotion purposes). As an illustration, consider an example in which it is decided that customers who tend to bet on the outright winner of a football match should also be presented with an opportunity to bet on the precise score of the game. Consider also another example in which it is decided that for customers who only place single bets, opportunities to promote double bets should be presented to those customers. Thus, under such circumstances, the rules applied to customer indices/profiles indicating such tendencies by the customers (e.g. to, in the above two example, pick an outright winner of football matches, or to place only single bets) may be configured to cause the index/profile to be modified for the purpose of generating the promotions associated with the above two examples, and have the promotions generated against the modified customer index, to thus promote the modified behavior. Thus, in such embodiments, pre-determined rules that are to be applied to and index or profile include rules configured to determine whether one or more of the parameters of an index represent a particular behavior, and based on a determination that the particular behavior is represented by the one or more parameters of the index, cause the index to be modified such that the modified index results in additional opportunities to be promoted in response to particular one or more future events.

To generate promotions for available opportunities (be it based on customer indices for specific customer, generic indices for locations or POS devices, or for profiles generated from several indices), the promotion record may be configured, in some embodiments, as follows:
ID: Unique identification value.
Affiliated to Profile: One or more index/profile ID that the promotion record is associated with.
Promotion Name: string, descriptive name, of the promotion record.
Importance: range, 1-99 (1 highest)—used to filter and order promotions per each index/profile.
Event Type: used to determine the promoted event type, and can include multiple selections, such as horse races, team sporting events, etc.
Visual Template: serves as a rule property to determine/specify the promotion's visual display template (which may be selected from a repository of pre-determined templates, or may include attributes specifying a unique visual configuration to use for presentation of the associated promotion).
Parameters alteration: Auto-complete, comma-delimited-multiple-value combo box, where:
   Each declared parameter includes a parameter alteration option to override the existing value/entire parameter within a customer's index.
   A parameter's value and range may be increased or decreased to serve the promotion's strategic purpose.
   Each of the parameters may be declared as mandatory as to its participation in the generation of the promotion.

In addition, a rule set(s) associated with promotions (e.g., to specify which promotions are to be presented and/or in what are order) may be retrieved by, for example, the promotion engine of a delivery station in a particular locale.

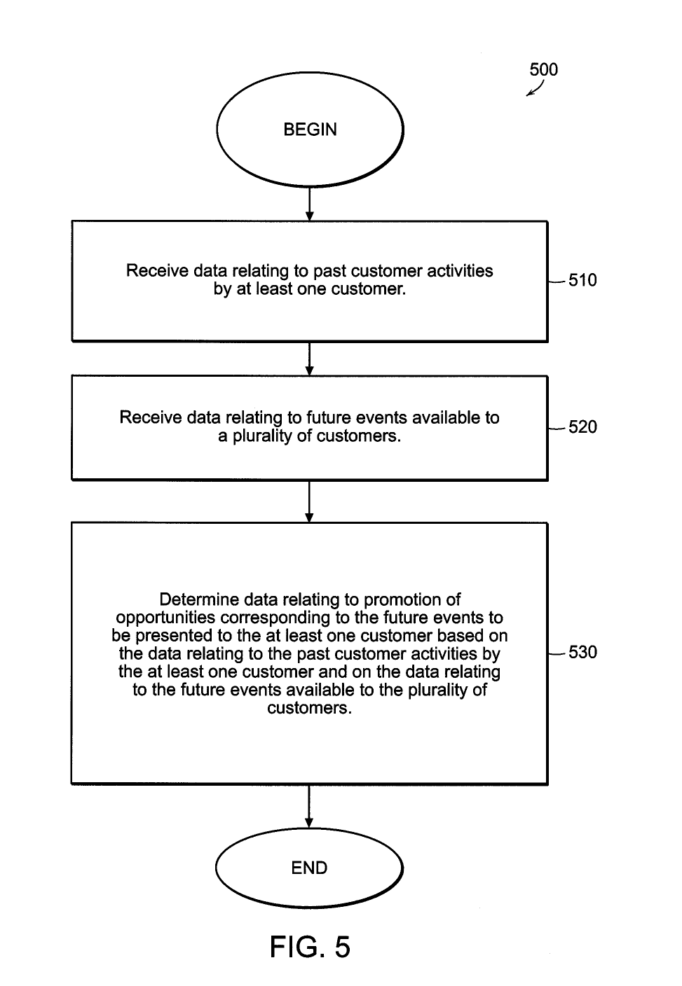

Thus, and with reference to FIG. 5, a flowchart of an example procedure 500 to generate and present promotions of commercial opportunities to customers (e.g., based on predictive analysis) is shown. Initially, data relating to past customer activities by at least one customer is received 510. In some embodiments, such data may be arranged in customer index records and/or profiles (which may correspond to several customers whose behavior is determined to be similar based on associated values of the parameters in the individual indices of those customers). Where the generation of promotion presentations are generated locally at an outlet or shop, the data may be sent by a remote server and received at a delivery station (e.g., like the delivery station 162 depicted in FIG. 1B) or a at POS device at the local outlet/shop.

Additionally, data relating to future events available to a plurality of customers is received 520. Here too, such data may be received at local machines deployed at the various outlets/shops where the commercial transactions by the customers are to take place. The data relating to future events may include a listing of various sporting events and the like, with respect to which bets can be place. Alternatively, in some embodiments, the data relating to future events may be received at one of the remote servers, and any further processing based on that data (e.g., determining/generating promotional materials) may be performed at those remote servers and subsequently sent to the local machines where clients review and select opportunities.

Subsequently, a determination is made 530 of data relating to promotions of opportunities corresponding to the future events to be presented to the at least one customer based on the data relating to the past customer activities by the at least one customer (e.g., as provided via the customer index), and based on the data relating to the future events available to the plurality of customers. In some implementations, promotion generation logic may be based on: a) properties of the various customer indices used, b) properties/attributes defined in relation to the data relating to future events (e.g., data compiled in a “Daily Events” record), and c) based on transaction properties sent by the various POS devices through which customers enter and complete their commercial transactions (e.g., time that a transaction was executed, wager placed, etc.)

In some embodiments, the system (100 and/or 150) may further be configured to generate cross-sale opportunities to customers who have just selected a commercial opportunity. Such a cross-sale opportunity may be based on the opportunity just selected by the customer, and on an effectiveness measure associated with another opportunity, or a combination of opportunities, that represents a likelihood that a customer who made an initial selection of a commercial opportunity (be it a betting opportunity, a purchasing opportunity of some sort, etc.) would select the other opportunity associated with that effectiveness measure. Further details regarding example procedures to determine and present cross-sale offers are described, for example, in U.S. application Ser. No. 12/697,867, entitled “PROCESSING OF COMMERCE-BASED ACTIVITIES,” and filed Feb. 1, 2010, the content of which is hereby incorporated by reference in its entirety.

Briefly, when a computing system receives (e.g., the server 110 of FIG. 1A, the servers 152 and/or 154 of FIG. 1B, a POS device, or a delivery station) information from the various POS devices regarding a transaction (e.g., a betting transaction) that is to be completed by the customer, or has been completed, the received information is used to determine one or more cross-sale offers to be offered to the customer.

In some embodiments, the one or more cross-sale offers are identified from a set of combinations that includes records, or entries, of combinations of one or more first opportunity (e.g., the type of bet that has been placed) and corresponding one or more second items, e.g., additional types of opportunities that may be offered as a cross-sale offer to a customer.

Each combination is generally associated with an effectiveness measure that represents the probability that a customer would accept the one or more second opportunity of that combination given that the customer already picked the associated one or more first opportunity. In some embodiments, the combination may also be associated with other data, such as a confidence interval representative of the uncertainly associated with effectiveness measures.

Thus, a communication sent by one the POS that includes information identifying one or more first opportunity selected by the customer is used to access a repository (such as the repository 120 depicted in FIG. 1A) maintaining combinations of a first opportunity and a second opportunity to determine those combinations that correspond to the first opportunity selected by the customer. In some embodiments, the combination associated with the highest effective measure is selected, and information based on that combination, including the identity of one or more second opportunity to be offered to the customer in a cross-sale offer is presented to the user. In some embodiments, several combinations may be selected (e.g., 3-5 combinations having the highest respective effectiveness measures), and a scheme incorporating a randomness element may be used to select one of those combinations so that more than one combination (corresponding to promotions) may have an opportunity to be presented to customers.

To illustrate the functionality of procedures to determine cross-sale offers of commercial opportunities relating to future events, consider, for example, a scenario in which a customer placed a bet of $10 on a particular horse in a horse race. Upon inputting the particulars of this opportunity (e.g., by the customer him/herself entering the order through a self-serve POS device), the information may be used to access a repository of combinations of selected opportunities and corresponding cross-sale opportunities, that includes, for example, combinations corresponding to a first selected opportunity of horse race betting (the combination may be more detailed than that, but for the purpose of illustration, a simplified combination corresponding to an initial selection of a horse racing bet will be used). Accordingly, the information regarding the initial selection by a customer of a horse racing betting opportunity is used to identify a sub-group of combinations where all the combinations in that sub-group correspond to an initial selection of a horse racing bet. Thus, in this particular example, a determined sub-group of combinations may include combinations of cross-sale offers of various other betting opportunities (such as, for example, a betting opportunity about a horse race at another track, a betting opportunity in relation to a football or basketball game, etc.). Having identified the sub-group of combinations, promotions to promote cross-sale offers, selected from the identified sub-group of combinations, of secondary opportunities, are determined, generated and presented to the customer. In some embodiments, the cross-sale offers of additional opportunities that are selected are those combinations from the sub-group having the highest effectiveness measures. In some embodiments, other criteria may be used in the selection process of the one or more second opportunities that are to be promoted to the customer. For example, in some implementations, the criterion used to select a combination from a determined sub-group of combinations may be the expected profit to be realized by successfully promoting the one or more second opportunity offered to the customer.

With the cross-sale offer information presented to the customer, the customer decides whether to accept the selected cross-sale opportunity offer. The outcome of the cross-sale transaction (i.e., the customer's decision to accept or not accept any part of the cross-sale offer) may be used to update the records of the repository of combinations.

The computing system used to implement the procedure described herein may be configured to perform computations to determine updated effectiveness measures associated with combinations corresponding to opportunities selected by a customer. In some embodiments, determination of cross-sale offers based on effectiveness measure are performed using a dynamic adaptive computation of probabilities/likelihoods of successful cross-sales of for each combination and a computation of an associated confidence interval value, representative of the uncertainly associated with the computed probability (i.e., representative of how sure we are of the computed probability), for that same combination. In some implementations, additional values may be associated with each combination that may be offered as a cross-sale.

Turning back to FIGS. 1A, 1B, and 2, each of the various systems, devices, components and modules depicted in FIG. 1, for example, any of the POS 102a-c and/or the computing system 110, may be processor-based systems that include a computer and/or other types of processor-based devices suitable for multiple applications. Such devices can include volatile and non-volatile memory elements, and peripheral devices to enable input/output functionality.

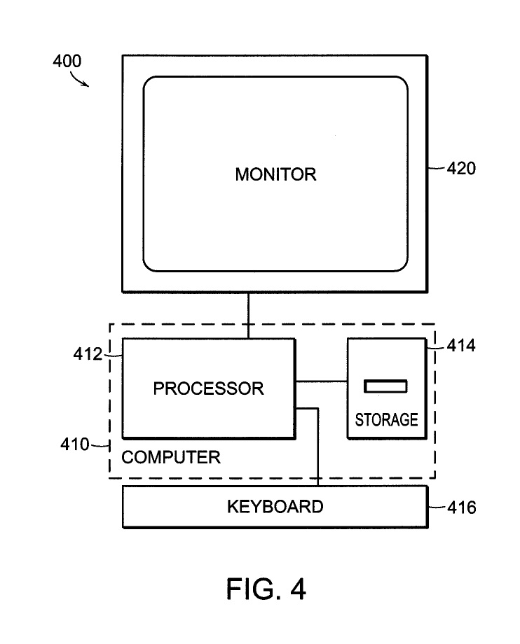

Specifically, and with reference to FIG. 4 showing a schematic diagram of a generic computing system 400 that may be used to implement any of the processor-based systems depicted in FIGS. 1A, 1B, and 2, the computing system 400 includes a processor-based device 410 such as a personal computer, a specialized computing device, and so forth, that typically includes a central processor unit 412. In addition to the CPU 412, the system includes main memory, cache memory and bus interface circuits (not shown). The processor-based device 410 includes a mass storage element 414, such as a hard drive associated with the computer system. In some embodiments, the mass storage element 414, when used in the implementations of computing system 110 shown in FIG. 1, may be used to implement the repository 120 to record and maintain data such as, for example, data regarding customer past behavior and commercial activities, data relating to combinations of a first and second opportunities, etc. The computing system 400 may further include a keyboard, or keypad, 416, and a monitor 420, e.g., a CRT (cathode ray tube) or LCD (liquid crystal display) monitor.

The processor-based device 410 is configured to facilitate, for example, the implementation of the processing of commerce-based activities, e.g., determining promotions of commercial opportunities (such as betting opportunities) based, at least in part, on customers' past commercial activities and behavior, and based on data regarding future events and opportunities associated therewith. The storage device 414 may thus also include a computer program product that when executed on the processor-based device 410 causes the processor-based device to perform operations to facilitate the implementation of the processing of commerce-based activities as described herein. The processor-based device may further include peripheral devices to enable input/output functionality. Such peripheral devices may include, for example, a CD-ROM drive and/or flash drive, or a network connection, for downloading related content to the connected system. Such peripheral devices may also be used for downloading software containing computer instructions to enable general operation of the respective system/device. Alternatively and/or additionally, in some embodiments, special purpose logic circuitry, e.g., an FPGA (field programmable gate array) or an ASIC (application-specific integrated circuit) may be used in the implementation of the system 400. Other modules that may be included with the processor-based device 410 are speakers, a sound card, a pointing device, e.g., a mouse or a trackball, by which the user can provide input to the computing system 400. The processor-based device 410 may include an operating system, e.g., Windows XP® Microsoft Corporation operating system. Alternatively, other operating systems could be used.

The various systems and devices constituting the systems 100, 150 and/or 200 may be connected using conventional network arrangements. For example, the various systems and devices of systems 100, 150, and/or 200, may constitute part of a private packet-based network. Other types of network communication protocols may also be used to communicate between the various systems and systems/devices. Alternatively, the systems and devices may each be connected to network gateways that enable communication via a public network such as the Internet. Network communication links between the systems and devices of systems 100, 150, and/or 200, may be implemented using wireless (including, for example, satellite-based implementations) or wire-based links. For example, in some embodiments, the computing systems may include broadcasting apparatus (e.g., an antenna, a transceiver such as a network gateway portal connected to a network, etc.) to transmit and receive data signals. Further, dedicated physical communication links, such as communication trunks may be used. Some of the various systems described herein may be housed on a single processor-based device (e.g., a server) configured to simultaneously execute several applications.

Various embodiments of the subject matter described herein may be realized in digital electronic circuitry, integrated circuitry, specially designed ASICs (application specific integrated circuits), computer hardware, firmware, software, and/or combinations thereof. These various embodiments may include embodiment in one or more computer programs that are executable and/or interpretable on a programmable system including at least one programmable processor, which may be special or general purpose, coupled to receive data and instructions from, and to transmit data and instructions to, a storage system, at least one input device, and at least one output device. Some embodiments include specific “modules” which may be implemented as digital electronic circuitry, integrated circuitry, specially designed ASICs (application specific integrated circuits), computer hardware, firmware, software, and/or combinations thereof.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

Some or all of the subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an embodiment of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server generally arises by virtue of computer programs running on the respective computers and having a client-server relationship to each other.

Although particular embodiments have been disclosed herein in detail, this has been done by way of example for purposes of illustration only, and is not intended to be limiting with respect to the scope of the appended claims, which follow. In particular, it is contemplated that various substitutions, alterations, and modifications may be made without departing from the spirit and scope of the invention as defined by the claims. Other aspects, advantages, and modifications are considered to be within the scope of the following claims. The claims presented are representative of the embodiments and features disclosed herein. Other unclaimed embodiments and features are also contemplated. Accordingly, other embodiments are within the scope of the following claims.

What is claimed is:

1. A method performed by execution of computer readable program code on one or more processing-based devices, the method comprising:
receiving data relating to past customer activities by at least one customer;
receiving data relating to future events available to a plurality of customers; and
determining data relating to promotion of opportunities corresponding to the future events to be presented to the at least one customer based on the data relating to the past customer activities by the at least one customer and on the data relating to the future events available to the plurality of customers.

2. The method of claim 1, wherein the past customer activities include betting activities.

3. The method of claim 1, wherein the data relating to past customer activities by the at least one customer includes data arranged in a customer index comprising parameters representative the behavior of the at least one customer, wherein each parameter of the customer is associated with a rank value representative of an importance of the respective parameter relative to other parameters of the index.

4. The method of claim 3, wherein the parameters comprises one or more of:
preferred odds favored by the at least one customer associated with the index, an average daily transactions representative of the number of transactions performed by the associated at least one customer during a single day, favorite subject data representative of individual subjects favored by the associated at least one customer, and percent stake wagers per event subject values representative of the percentages of bets the associated at least one customer wagers on respective event subjects.

5. The method of claim 3, wherein determining promotion of the future events comprises:
generating a promotion presentation promoting at least one of the opportunities corresponding to the future events to be presented to the at least one customer based, at least in part, on the rank values for the parameters of the customer index for the at least one customer.

6. The method of claim 5, wherein the generated promotion presentation includes the at least one future event and customer options available in relation to the at least one future event.

7. The method of claim 6, wherein the available customer options include betting options determined based on the customer index parameters for the at least one customer to which the generated promotion is presented.

8. The method of claim 5, wherein generating the promotion presentation promoting the at least one of the future events comprises:
generating the promotion presentation based, at least in part, on the rank values for at least some of the parameters of the customer index for the at least one customer and using pre-determined rules applied to the data arranged in customer index.

9. The method of claim 8, wherein the pre-determined rules include rules configured to cause:
determining whether one or more of the parameters of the index represent a particular behavior; and
based on a determination that the particular behavior is represented by the one or more parameters of the index, causing the index to be modified such that the modified index results in additional opportunities to be promoted in response to particular one or more future events.

10. The method of claim 1, wherein the data relating to past customer activities by the at least one customer includes data arranged in a plurality of customer indices comprising parameters representative the behavior of respective customers associated with each of the plurality of customer indices, wherein each parameter in each of the plurality of customer indices is associated with a rank value representative of an importance of the respective parameter relative to other parameters in the respective index;
wherein the method further comprises:
selecting at least some of the parameters of each of the plurality of customer indices, the selected at least some of the parameters corresponding to parameters with respect to which the respective customers associated with each of the plurality of customer indices include data representative of similar behavior for all of the respective customers associated with each of the plurality of customer indices for the selected at least some of the parameters.

11. The method of claim 1, further comprising:
communicating the data relating to promotion of the opportunities corresponding to the future events to one or more point-of-sale devices deployed in one or more geographical locations.

12. The method of claim 1, further comprising:
receiving information about a transaction, the transaction including information about a first commercial opportunity selected by the at least one customer from one or more available opportunities;
determining at least one second commercial opportunity to be presented to the at least one customer based on the received information and based on effective measures that are each associated with at least one combination from a set of combinations that each includes the first commercial opportunity selected by the customer and a corresponding offer of cross-sale of at least one other commercial opportunity from a plurality of commercial opportunities, each of the effectiveness measures being representative of a likelihood that the at least one other commercial opportunity to be offered to the at least one customer would be accepted when offered in combination with the first commercial opportunity selected by the at least one customer; and
communicating information to the customer about a cross-sale offer to select the determined at least one second commercial opportunity.

13. A computer program product residing on a computer readable storage device comprising computer instructions that when executed on one or more processor-based devices cause the one or more processor-based devices to:
receive data relating to past customer activities by at least one customer;
receive data relating to future events available to a plurality of customers; and
determine data relating to promotion of opportunities corresponding to the future events to be presented to the at least one customer based on the data relating to the past customer activities by the at least one customer and on the data relating to the future events available to the plurality of customers.

14. The computer program product of claim 13, wherein the data relating to past customer activities by the at least one customer includes data arranged in a customer index comprising parameters representative the behavior of the at least one customer, wherein each parameter of the customer is associated with a rank value representative of an importance of the respective parameter relative to other parameters of the index.

15. The computer program product of claim 14, wherein the computer instructions further include instructions to further cause the one or more processor-based devices to:
generate a promotion presentation promoting at least one of the opportunities corresponding to the future events to be presented to the at least one customer based, at least in part, on the rank values for the parameters of the customer index for the at least one customer.

16. A system comprising:
at least one processor-based device; and
a storage device coupled to the at least one processor-based device, the storage device storing computer instructions that when executed on the at least one processor-based device cause the at least one processor-based device to:
receive data relating to past customer activities by at least one customer;
receive data relating to future events available to a plurality of customers; and
determine data relating to promotion of opportunities corresponding to the future events to be presented to the at least one customer based on the data relating to the past customer activities by the at least one customer and on the data relating to the future events available to the plurality of customers.

17. The system of claim 16, wherein the data relating to past customer activities by the at least one customer includes data arranged in a customer index comprising parameters representative the behavior of the at least one customer, wherein each parameter of the customer is associated with a rank value representative of an importance of the respective parameter relative to other parameters of the index.

18. The system of claim 17, wherein the computer instructions further include instructions to further cause the at least one processor-based device to:
generate a promotion presentation promoting at least one of the opportunities corresponding to the future events to be presented to the at least one customer based, at least in part, on the rank values for the parameters of the customer index for the at least one customer.

19. The system of claim 18, wherein the generated promotion includes the at least one future event and customer betting options available in relation to the at least one future event.

20. The system of claim 16, further comprising:
a point-of-sale (POS) device including:
a display device,
a user input device to receive user input including user selection of an opportunity from the opportunities corresponding to the determined data relating to the promotion of the opportunities, and
a communication transceiver to transmit to the at least one processor-based device at least the user selection.
